(19) United States
(12) Patent Application Publication
(10) Pub. No.: US 2024/0319462 A1
(43) Pub. Date: Sep. 26, 2024

(54) OPTICAL FIBER AND OPTICAL FIBER RIBBON

(71) Applicant: SUMITOMO ELECTRIC INDUSTRIES, LTD., Osaka-shi, Osaka (JP)

(72) Inventors: Noriaki IWAGUCHI, Osaka-shi, Osaka (JP); Miho IKEGAWA, Osaka-shi, Osaka (JP); Chiaki TOKUDA, Osaka-shi, Osaka (JP)

(73) Assignee: SUMITOMO ELECTRIC INDUSTRIES, LTD., Osaka-shi, Osaka (JP)

(21) Appl. No.: 18/281,687

(22) PCT Filed: Jan. 27, 2022
(86) PCT No.: PCT/JP2022/003116

§ 371 Date: Sep. 12, 2023

(30) Foreign Application Priority Data
Mar. 18, 2021 (JP) 2021-044426

(51) Int. Cl. G02B 6/44; C03C 25/1065; C03C 25/285; C03C 25/40; G02B 6/02

(52) U.S. Cl. CPC G02B 6/4403; C03C 25/1065; C03C 25/285; C03C 25/40; G02B 6/02395

(57) ABSTRACT

An optical fiber comprises a glass fiber including a core and a cladding, and a coating resin layer for coating the glass fiber; the coating resin layer has a primary resin layer in contact with the glass fiber for coating the glass fiber, and a secondary resin layer for coating the primary resin layer; the primary resin layer includes a silicone resin; the secondary resin layer includes a urethane (meth)acrylate resin; and the amount of platinum contained in the primary resin layer is 25 ppm or more and 280 ppm or less in a mass ratio.

### TECHNICAL FIELD

The present disclosure relates to an optical fiber and an optical fiber ribbon.

The present application claims priority based on Japanese Patent Application No. 2021-044426 filed on Mar. 18, 2021, and incorporates all the content described in the Japanese Patent Application.

### BACKGROUND ART

Generally, an optical fiber has a coating resin layer for protecting a glass fiber as light transmitting medium. The coating resin layer includes, for example, two layers consisting of a primary resin layer in contact with the glass fiber and a secondary resin layer formed as outer layer of the primary resin layer.

In recent years, the demand for high-density cables with increased packing density of optical fibers has increased in data center applications. With increase in the packing density of optical fibers in a cable, a lateral pressure is applied to the optical fibers, so that microbending loss tends to increase. In order to improve the lateral pressure resistance of optical fibers, coating resins have been developed. For example, an optical fiber having a coating resin layer including a primary resin layer containing a silicone resin and a secondary resin layer containing a urethane (meth)acrylate resin is known (refer to the following Patent Literature 1).

### CITATION LIST

### Patent Literature

Patent Literature 1: JP S58-211707 A

### SUMMARY OF INVENTION

An optical fiber according to an embodiment of the present disclosure comprises a glass fiber including a core and a cladding, and a coating resin layer for coating the glass fiber; the coating resin layer has a primary resin layer in contact with the glass fiber for coating the glass fiber, and a secondary resin layer for coating the primary resin layer; the primary resin layer includes a silicone resin; the secondary resin layer includes a urethane (meth)acrylate resin; and the amount of platinum contained in the primary resin layer is 25 ppm or more and 280 ppm or less in a mass ratio.

An optical fiber ribbon according to an embodiment of the present disclosure comprises a plurality of the optical fibers arranged in parallel and a connecting resin layer for coating and connecting a plurality of the optical fibers.

### BRIEF DESCRIPTION OF DRAWINGS

FIG. 1 is a schematic cross-sectional view showing an example of an optical fiber according to the present embodiment.

FIG. 2 is a schematic cross-sectional view showing an example of an optical fiber ribbon according to the present embodiment.

### DESCRIPTION OF EMBODIMENTS

### Problem to be Solved by the Present Disclosure

Since a silicone resin has lower polarity in comparison with a urethane (meth)acrylate resin, an optical fiber having a coating resin layer including a primary resin layer containing a silicone resin, and a secondary resin layer containing a urethane (meth)acrylate resin may have insufficient adhesion between the primary resin layer and the secondary resin layer.

An object of the present disclosure is to provide an optical fiber having superior adhesion between the primary resin layer and the secondary resin layer, and an optical fiber ribbon.

### Effects of the Present Disclosure

According to the present disclosure, an optical fiber having superior adhesion between the primary resin layer and the secondary resin layer, and an optical fiber ribbon can be provided.

### Description of Embodiments of the Present Disclosure

First, the contents of the embodiments of the present disclosure are enumerated in the description. An optical fiber according to an embodiment of the present disclosure comprises a glass fiber including a core and a cladding, and a coating resin layer for coating the glass fiber; the coating resin layer has a primary resin layer in contact with the glass fiber for coating the glass fiber, and a secondary resin layer for coating the primary resin layer; the primary resin layer includes a silicone resin; the secondary resin layer includes a urethane (meth)acrylate resin; and the amount of platinum contained in the primary resin layer is 25 ppm or more and 280 ppm or less in a mass ratio.

A platinum catalyst may be used for curing the silicone resin contained in the primary resin layer. Since the platinum catalyst remains in the resin layer even after synthesis of the silicone resin, the primary resin layer contains platinum derived from the platinum catalyst. With an insufficient amount of the platinum catalyst added, the reaction of the silicone compound used to synthesize the silicone resin becomes insufficient, and the unreacted silicone compound migrates to the interface between the primary resin layer and the secondary resin layer, so that adhesion at the interface between the primary resin layer and the secondary resin layer tends to decrease. On the other hand, with an increase of the amount of the platinum catalyst added, the remained platinum catalyst migrates to the interface between the primary resin layer and the secondary resin layer, so that adhesion at the interface between the primary resin layer and the secondary resin layer tends to decrease. The optical fiber according to the present disclosure can improve the adhesion between the primary resin layer containing a silicone resin and the secondary resin layer containing a urethane (meth)acrylate by controlling the amount of platinum contained in the primary resin layer.

From the viewpoint of excellence in the lateral pressure resistance, the primary resin layer may be a cured product of a first resin composition containing a silicone compound having a vinylsilyl group, a silicone compound having a hydrosilyl group, and a platinum catalyst.

From the viewpoint of excellence in the lateral pressure resistance, the secondary resin layer may be a cured product of a second resin composition containing a urethane (meth)acrylate and a photopolymerization initiator.

From the viewpoint of more excellence in the adhesion between the primary resin layer and the secondary resin layer, the second resin composition may further contain an epoxy (meth)acrylate having an aromatic ring.

The optical fiber ribbon according to an embodiment of the present disclosure comprises a plurality of the optical fibers arranged in parallel and a connecting resin layer for coating and connecting a plurality of the optical fibers. Such an optical fiber ribbon can suppress delamination between the primary resin layer and the secondary resin layer of the optical fiber in single-fiber separation.

### Details of Embodiments of the Present Disclosure

Specific examples of the optical fiber and the optical fiber ribbon according to embodiments of the present disclosure will be described with reference to drawings as necessary. The present disclosure is not limited to these examples, being shown in the scope of claims and intended to include equivalents to the claims and all modifications within the scope of the claims. In the following description, the same elements will be denoted by the same reference numerals in the description of the drawings, and duplicate description will be omitted. In the present embodiment, a (meth)acrylate means an acrylate or a methacrylate corresponding to the same, and the same applied to other similar expressions such as a (meth)acrylic acid.

### (Optical Fiber)

The optical fiber according to the present embodiment comprises a glass fiber including a core and a cladding, and a coating resin layer for coating the glass fiber. The coating resin layer has a primary resin layer in contact with the glass fiber for coating the glass fiber, and a secondary resin layer for coating the primary resin layer.

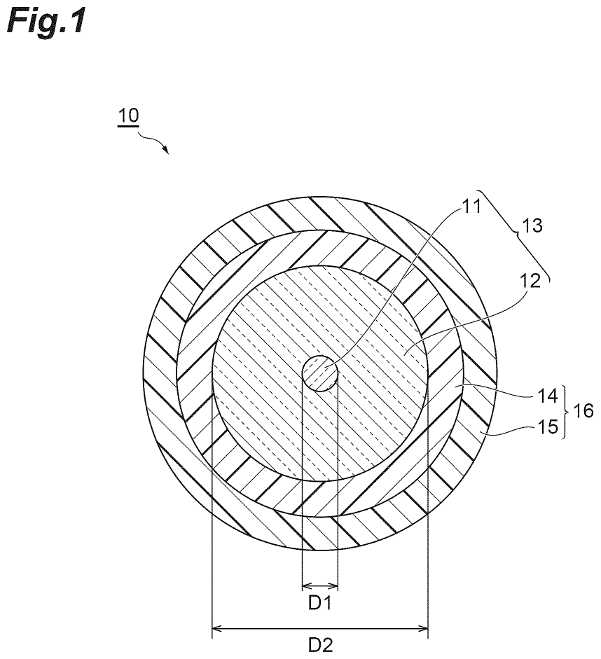

FIG. 1 is a schematic cross-sectional view showing an example of an optical fiber according to the present embodiment. An optical fiber 10 includes a glass fiber 13 including a core 11 and a cladding 12, and a coating resin layer 16 including a primary resin layer 14 and a secondary resin layer 15 provided on the outer periphery of the glass fiber 13.

The cladding 12 surrounds the core 11. The core 11 and the cladding 12 mainly include glass such as silica glass. For example, the core 11 may be made of silica glass with addition of germanium or pure silica glass, and the cladding 12 may be made of pure silica glass or silica glass with addition of fluorine.

In FIG. 1, for example, the outer diameter (D2) of the glass fiber 13 is about 100 μm to 125 μm, and the diameter (D1) of the core 11 constituting the glass fiber 13 is about 7 μm to 15 μm. The thickness of the coating resin layer 16 is usually about 22 μm to 70 μm. The thickness of each of the primary resin layer 14 and the secondary resin layer 15 may be about 5 μm to 50 μm.

In the case where the outer diameter (D2) of the glass fiber 13 is about 125 μm and the thickness of the coating resin layer 16 is 60 μm or more and 70 μm or less, the thickness of each of the primary resin layer 14 and the secondary resin layer 15 may be about 10 μm to 50 μm, and, for example, the thickness of the primary resin layer 14 may be 35 μm and the thickness of the secondary resin layer 15 may be 25 μm. The outer diameter of the glass fiber 10 may be about 245 μm to 265 μm.

In the case where the outer diameter (D2) of the glass fiber 13 is about 125 μm and the thickness of the coating resin layer 16 is 24 μm or more and 48 μm or less, the thickness of each of the primary resin layer 14 and the secondary resin layer 15 may be about 8 μm to 38 μm, and, for example, the thickness of the primary resin layer 14 may be 25 μm and the thickness of the secondary resin layer 15 may be 10 μm. The outer diameter of the glass fiber 10 may be about 173 μm to 221 μm.

In the case where the outer diameter (D2) of the glass fiber 13 is about 100 μm and the thickness of the coating resin layer 16 is 22 μm or more and 37 μm or less, the thickness of each of the primary resin layer 14 and the secondary resin layer 15 may be about 5 μm to 32 μm, and, for example, the thickness of the primary resin layer 14 may be 25 μm and the thickness of the secondary resin layer 15 may be 10 μm. The outer diameter of the glass fiber 10 may be about 144 μm to 174 μm.

The primary resin layer 14 includes a silicone resin. The silicone resin can be obtained by addition reaction of a silicone compound having a vinylsilyl group and a silicone compound having a hydrosilyl group in the presence of a platinum catalyst. In other words, the primary resin layer 14 can be formed from a first resin composition containing a silicone compound having a vinylsilyl group, a silicone compound having a hydrosilyl group, and a platinum catalyst. The first resin composition is a thermosetting resin composition.

In the primary resin layer, platinum derived from a platinum catalyst is contained. The amount of platinum contained in the primary resin layer is 25 ppm or more and 280 ppm or less based on the total amount of the primary resin layer. With an amount of platinum contained in the primary resin layer of 25 ppm or more, the reaction of the silicone compound to synthesize the silicone resin can be promoted, so that the decrease in adhesion between the primary resin layer and the secondary resin layer resulting from migration of the unreacted silicone compound to the interface between the primary resin layer and the secondary resin layer can be suppressed. With an amount of platinum contained in the primary resin layer of 280 ppm or less, the decrease in adhesion between the primary resin layer and the secondary resin layer resulting from migration of the platinum catalyst remaining in the primary resin layer to the interface between the primary resin layer and the secondary resin layer can be suppressed. The amount of platinum contained in the primary resin layer is expressed in a mass ratio and can be measured by ICP mass spectrometry. The amount of platinum contained in the primary resin layer can be adjusted by the amount of platinum catalyst added in synthesis of the silicone resin.

The amount of platinum contained in the primary resin layer may be 30 ppm or more, 40 ppm or more, or 50 ppm or more, and may be 260 ppm or less, 240 ppm or less, 220 ppm or less, 200 ppm or less, 180 ppm or less, or 160 ppm or less. The amount of platinum contained in the primary resin layer is particularly preferably 50 ppm or more and 150 ppm or less from the viewpoint of more excellent adhesion between the primary resin layer and the secondary resin layer. The amount of platinum contained in the primary resin layer may be 60 ppm or more, 70 ppm or more, 80 ppm or more, or 90 ppm or more, and may be 140 ppm or less, 130 ppm or less, 120 ppm or less, or 110 ppm or less.

The platinum catalyst is not particularly limited as long as it is a platinum catalyst generally used for synthesizing a silicone resin. Examples of the platinum catalyst include a platinum black and a platinum compound. Examples of the platinum compound include chloroplatinic acid, a reaction product of chloroplatinic acid and a monohydric alcohol, and a complex of chloroplatinic acid and an olefin compound.

The silicone compound having a vinylsilyl group is a silicone compound having a vinyl group bonded to a silicon atom. The silicone compound having a vinylsilyl group may have one vinylsilyl group in one molecule, or may have two or more vinylsilyl groups in one molecule. The vinylsilyl group may be contained at the terminal of the molecular main chain of the silicone compound, may be contained in the molecular side chain of the silicone compound, or may be contained in both the terminal of the molecular main chain and the molecular side chain of the silicone compound.

The silicone compound having a vinylsilyl group may further have at least one organic group selected from a group consisting of an alkyl group having 1 to 6 carbon atoms, an aryl group having 6 to 10 carbon atoms, and an aralkyl group having 7 to 10 carbon atoms. The alkyl group having 1 to 6 carbon atoms may be linear, branched or cyclic. Examples of the organic group include a methyl group, an ethyl group, a propyl group, a butyl group, a cyclohexyl group, a cyclobutyl group, a phenyl group and a tolyl group. These organic groups may be groups in which some or all of the hydrogen atoms are replaced with halogen atoms, cyano groups, or the like.

From the viewpoint of coating stability, the weight average molecular weight of the silicone compound having a vinylsilyl group may be 1000 or more, 3000 or more, or 6000 or more. The upper limit of the weight average molecular weight of the silicone compound having a vinylsilyl group is not particularly limited, and may be 100000.

The silicone compound having a vinylsilyl group may be used alone or in combination of two or more.

The silicone compound having a hydrosilyl group is a silicone compound having a hydrogen atom bonded to a silicon atom. The silicone compound having a hydrosilyl group may have one hydrosilyl group in one molecule, or may have two or more hydrosilyl groups in one molecule. The hydrosilyl group may be contained at the terminal of the molecular main chain of the silicone compound, may be contained in the molecular side chain of the silicone compound, or may be contained in both the terminal of the molecular main chain and the molecular side chain of the silicone compound.

The silicone compound having a hydrosilyl group may further have at least one organic group selected from a group consisting of an alkyl group having 1 to 6 carbon atoms, an aryl group having 6 to 10 carbon atoms, and an aralkyl group having 7 to 10 carbon atoms. The alkyl group having 1 to 6 carbon atoms may be linear, branched or cyclic. Examples of the organic groups include a methyl group, an ethyl group, a propyl group, a butyl group, a cyclohexyl group, a cyclobutyl group, a phenyl group and a tolyl group. These organic groups may be groups in which some or all of the hydrogen atoms are replaced with halogen atoms, cyano groups, or the like.

From the viewpoint of coating stability, the weight average molecular weight of the silicone compound having a hydrosilyl group may be 1000 or more, 3000 or more, or 6000 or more. The upper limit of the weight average molecular weight of the silicone compound having a hydrosilyl group is not particularly limited, and may be 100000.

The silicone compound having a hydrosilyl group may be used alone or in combination of two or more.

The amounts of the silicone compound having a vinylsilyl group and the silicone compound having a hydrosilyl group blended can be adjusted by the molar ratio between the vinylsilyl group (Si(CH—CH₂)) in the silicone compound having a vinylsilyl group and the hydrosilyl group (SiH) in the silicone compound having a hydrosilyl group, i.e. Si(CH═CH₂)/SiH. From the viewpoint of curability, the molar ratio Si(CH═CH₂)/SiH may be less than 1. From the viewpoint of suppressing the transmission loss of an optical fiber, the molar ratio Si(CH═CH₂)/SiH may be 1 or more.

The first resin composition for forming the primary resin layer may be prepared with reference to JP S61-191545 A.

The Young's modulus of the primary resin layer may be 2.0 MPa or less or 1.5 MPa or less at 23° C. from the viewpoint of improving the lateral pressure resistance of an optical fiber. The Young's modulus of the primary resin layer may be 0.1 MPa or more at 23° C.

The secondary resin layer 15 includes a urethane (meth)acrylate resin. The urethane (meth)acrylate resin may be formed by curing a second resin composition containing a urethane (meth)acrylate and a photopolymerization initiator through ultraviolet irradiation. In other words, the second resin layer 15 may be formed from a second resin composition containing a urethane (meth)acrylate and a photopolymerization initiator. The second resin composition is a photocurable resin composition.

The urethane (meth)acrylate may be a compound obtained by reacting a polyol compound, a polyisocyanate compound and a hydroxy group-containing (meth)acrylate compound. Examples of the polyol compound include polytetramethylene glycol, polypropylene glycol and bisphenol A/ethylene oxide addition diol. From the viewpoint of adjusting the Young's modulus, the number average molecular weight (Mn) of the polyol compound may be 300 or more and 8000 or less, 400 or more and 5000 or less, or 500 or more and 4000 or less. Examples of the polyisocyanate compound include 2,4-tolylene diisocyanate, 2,6-tolylene diisocyanate, isophorone diisocyanate and dicyclohexylmethane 4,4′-diisocyanate. Examples of the hydroxyl group-containing (meth)acrylate compound include 2-hydroxyethyl (meth)acrylate, 2-hydroxybutyl (meth)acrylate, 1,6-hexanediol mono(meth)acrylate, pentaerythritol tri(meth)acrylate, 2-hydroxypropyl (meth)acrylate and tripropylene glycol (meth)acrylate.

An organotin compound is generally used as a catalyst for synthesizing urethane (meth)acrylate. Examples of the organotin compound include dibutyltin dilaurate, dibutyltin diacetate, dibutyltin malate, dibutyltin bis(2-ethylhexyl mercaptoacetate), dibutyltin bis(isooctyl mercaptoacetate), and dibutyltin oxide. From the viewpoints of easy availability and catalytic performance, it is preferable to use dibutyltin dilaurate or dibutyltin diacetate as an organotin compound.

A lower alcohol having 5 or less carbon atoms may be used for synthesizing the urethane (meth)acrylate. Examples of the lower alcohol include methanol, ethanol, 1-propanol, 2-propanol, 1-butanol, 2-butanol, 2-methyl-2-propanol, 1-pentanol, 2-pentanol, 3-pentanol, 2-methyl-1-butanol, 3-methyl-1-butanol, 2-methyl-2-butanol, 3-methyl-2-butanol, and 2,2-dimethyl-1-propanol.

The contents of urethane (meth)acrylate based on the total amount of the second resin composition may be 20 parts by mass or more, 25 parts by mass or more, or 30 parts by mass or more, and may be 90 parts by mass or less, 80 parts by mass or less, or 70 parts by mass or less.

The second resin composition may further contain an epoxy (meth)acrylate from the viewpoint of adjusting the Young's modulus of the secondary resin layer. The epoxy (meth)acrylate is a compound obtained by reacting an epoxy compound having two or more glycidyl groups and a compound having a (meth)acryloyl group. From the viewpoint of further improving the adhesion between the primary resin layer and the secondary resin layer, it is preferable that the epoxy (meth)acrylate have an aromatic ring. Since the epoxy (meth)acrylate having an aromatic ring is highly hydrophobic, it is presumed that the secondary resin layer obtained from the second resin composition containing the epoxy (meth)acrylate having an aromatic ring has more excellent adhesion to the primary resin layer containing a highly hydrophobic silicone resin. Examples of the epoxy (meth)acrylates having an aromatic ring include a (meth)acrylic acid adduct of bisphenol A diglycidyl ether. Examples of commercially available epoxy (meth)acrylates having an aromatic ring include a novolac epoxy (meth)acrylate, trade name “Biscoat #540” manufactured by Osaka Organic Chemical Industry Ltd., and trade names “Epoxy ester 3002M”, “Epoxy ester 3002A”, “Epoxy ester 3000MK”, and “Epoxy ester 3000A” manufactured by Kyoeisha Chemical Co., Ltd.

The content of the epoxy (meth)acrylate having an aromatic ring based on the total amount of the second resin composition may be 5 parts by mass or more, 10 parts by mass or more, 15 parts by mass or more, 20 parts by mass, or 25 parts by mass or more, and 70 parts by mass or less, 65 parts by mass or less, 60 parts by mass or less, 50 parts by mass or less, or 40 parts by mass or less.

The second resin composition may further contain a photopolymerizable compound (hereinafter referred to as “monomer”) other than urethan (meth)acrylate and epoxy (meth)acrylate. As the monomer, a monofunctional monomer having one polymerizable group and a polyfunctional monomer having two or more polymerizable groups may be used. One type of monomer may be used alone, or two or more types may be used in combination.

Examples of the monofunctional monomer include (meta)acrylate-based monomers such as methyl (meth)acrylate, ethyl (meth)acrylate, propyl (meth)acrylate, n-butyl (meth)acrylate, s-butyl (meth)acrylate, tert-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meta)acrylate, isooctyl (meth)acrylate, isodecyl (meth)acrylate, lauryl (meth)acrylate, 2-phenoxyethyl (meth)acrylate, 3-phenoxybenzyl acrylate, phenoxydiethylene glycol acrylate, phenoxypolyethylene glycol acrylate, 4-tert-butylcyclohexanol acrylate, tetrahydrofurfuryl (meth)acrylate, benzyl (meth)acrylate, dicyclopentenyl (meth)acrylate, dicyclopentenyloxyethyl (meth)acrylate, dicyclopentanyl (meth)acrylate, nonylphenolpolyethylene glycol (meta)acrylate, nonylphenol ethylene oxide-modified (meth)acrylate, nonylphenoxypolyethylene glycol (meth)acrylate, and isobornyl (meth)acrylate; carboxyl group-containing monomers such as (meth)acrylic acid, (meth)acrylic acid dimer, carboxyethyl (meth)acrylate, carboxypentyl (meth)acrylate, and ω-carboxy-polycaprolactone (meth)acrylate; heterocyclic ring-containing (meth)acrylates such as N-acryloyl morpholine, N-vinylpyrrolidone, N-vinylcaprolactam, N-acryloyl piperidine, N-methacryloyl piperidine, N-acryloyl pyrrolidine, 3-(3-pyridyl)propyl (meth)acrylate, and cyclic trimethylolpropane formal acrylate; maleimide-based monomers such as maleimide, N-cyclohexyl maleimide, and N-phenyl maleimide; N-substituted amide-based monomers such as (meth)acrylamide, N,N-dimethyl (meth)acrylamide, N,N-diethyl (meth)acrylamide, N-hexyl (meth)acrylamide, N-methyl (meth)acrylamide, N-ethyl (meth)acrylamide, N-butyl (meth)acrylamide, N-methylol (meth)acrylamide, and N-methylolpropane (meth)acrylamide; aminoalkyl (meth)acrylate-based monomers such as aminoethyl (meth)acrylate, aminopropyl (meth)acrylate, N,N-dimethylaminoethyl (meth)acrylate, and tert-butylaminoethyl (meth)acrylate; and succinimide-based monomers such as N-(meth)acryloyl oxymethylene succinimide, and N-(meth)acryloyl-6-oxyhexamethylene succinimide, and N-(meth)acryloyl-8-oxyoctamethylene succinimide.

Examples of the polyfunctional monomer include ethylene glycol di(meth)acrylate, polyethylene glycol di(meth)acrylate, polypropylene glycol di(meth)acrylate, neopentyl glycol di(meth)acrylate, tripropylene glycol di(meth)acrylate, di(meth)acrylate of alkylene oxide adduct of bisphenol A, tetraethylene glycol di(meth)acrylate, neopentyl glycol hydroxypivalate di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecane diol di(meth)acrylate, 1,20-eicosane diol di(meth)acrylate, isopentyl diol di(meth)acrylate, 3-ethyl-1,8-octane diol di(meth)acrylate, di(meth)acrylate of ethylene oxide adduct of bisphenol A, trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxypolypropoxy tri(meth)acrylate, tris[(meth)acryloyloxyethyl]isocyanurate, pentaerythritol tri(meth)acrylate, pentaerythritol polyethoxy tetra(meth)acrylate, pentaerythritol polypropoxy tetra(meth)acrylate, pentaerythritol tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, and caprolactone-modified tris[(meta)acryloyloxyethyl]isocyanurate.

The photopolymerization initiator for use may be appropriately selected from known radical photopolymerization initiators. Examples of the photopolymerization initiators include 1-hydroxycyclohexyl phenyl ketone (Omnirad 184, manufactured by IGM Resins), 2,2-dimethoxy-2-phenylacetophenone, 1-(4-isopropylphenyl)-2-hydroxy-2-methylpropane-1-one, bis(2,6-dimethoxybenzoyl)-2,4,4-trimethylpentylphosphine oxide, 2-methyl-1-[4-(methylthio)phenyl]-2-morpholino-propane-1-one (Omnirad 907, manufactured by IGM Resins), 2,4,6-trimethylbenzoyldiphenylphosphine oxide (Omnirad TPO, manufactured by IGM Resins), and bis(2,4,6-trimethylbenzoyl)phenylphosphine oxide (Omnirad 819, manufactured by IGM Resins).

The second resin composition may further contain a silane coupling agent, a photoacid generator, a leveling agent, an antifoaming agent, an antioxidant, a sensitizer, etc.

The silane coupling agent is not particularly limited as long as it causes no inhibition in curing of the resin composition. Examples of the silane coupling agent include tetramethyl silicate, tetraethyl silicate, mercaptopropyl trimethoxysilane, vinyltrichlorosilane, vinyltriethoxysilane, vinyltris(β-methoxy-ethoxy)silane, β-(3,4-epoxycyclohexyl)-ethyltrimethoxysilane, dimethoxydimethylsilane, diethoxydimethylsilane, 3-acryloxypropyl trimethoxysilane, 3-glycidoxypropyl trimethoxysilane, 3-glycidoxypropylmethyl diethoxysilane, 3-methacryloxypropyl trimethoxysilane, N-(β-aminoethyl)-γ-aminopropyltrimethoxysilane, N-(β-aminoethyl)-γ-aminopropyltrimethyl dimethoxysilane, N-phenyl-3-aminopropyl trimethoxysilane, 3-chloropropyl trimethoxysilane, 3-mercaptopropyl trimethoxysilane, 3-aminopropyl trimethoxysilane, bis-[3-(triethoxysilyl)propyl]tetrasulfide, bis-[3-(triethoxysilyl)propyl]disulfide, γ-trimethoxysilylpropyl dimethylthiocarbamyl tetrasulfide, and Y-trimethoxysilylpropyl benzothiazyl tetrasulfide.

As the photoacid generator, an onium salt having an A′B-structure may be used. Examples of the photoacid generator include a sulfonium salt such as UVACURE1590 (manufactured by Daicel-Cytec), CPI-100P, 110P, and 210S (manufactured by San-Apro), and an iodonium salt such as Omnicat 250 (manufactured by IGM Resins), WPI-113 (manufactured by Fujifilm Wako Pure Chemical Corporation), and Rp-2074 (manufactured by Rhodia Japan).

From the viewpoint of improving the lateral pressure resistance of an optical fiber, the Young's modulus of the secondary resin layer at 23° C. may be 100 MPa or more, 200 MPa or more, or 300 MPa or more. The Young's modulus of the secondary resin layer at 23° C. may be 2000 MPa or less.

The coating resin layer 16 on the outer peripheral surface of the secondary resin layer 15 may further include a colored layer to identify the optical fiber. Alternatively, the coating resin layer 16 may include the secondary resin layer 15 as a colored layer. It is preferable that the colored layer contains a pigment, from the viewpoint of improving identification of the optical fiber. Examples of the pigment include a colored pigment such as carbon black, titanium oxide and zinc oxide, a magnetic powder such as γ-Fe₂O₃, a mixed crystal of γ-Fe₂O₃ and γ-Fe₃O₄. CrO₂, cobalt ferrite, cobalt-deposited iron oxide, barium ferrite, Fe—Co and Fe—Co—Ni, an inorganic pigment such as MIO, zinc chromate, strontium chromate, aluminum tripolyphosphate, zinc, alumina, glass and mica; and an organic pigment such as an azo-based pigment, a phthalocyanine-based pigment, and a dyed lake pigment. The pigment may be subjected to treatments such as various types of surface modification and pigment hybridization.

The optical fiber according to the present embodiment may be prepared by a method including a step of applying a first resin composition to the outer periphery of the glass fiber and then curing the first resin composition by heating to form a primary resin layer (step of forming primary resin layer), and a step of applying a second resin composition to the outer periphery of the primary resin layer and then curing the second resin composition by irradiation with ultraviolet rays to form a secondary resin layer (step of forming secondary resin layer).

### (Optical Fiber Ribbon)

An optical fiber ribbon may be prepared by using the optical fiber according to the present embodiment. An optical fiber ribbon according to the present embodiment includes a plurality of optical fibers arranged in parallel and a connecting resin layer for coating and connecting a plurality of the optical fibers.

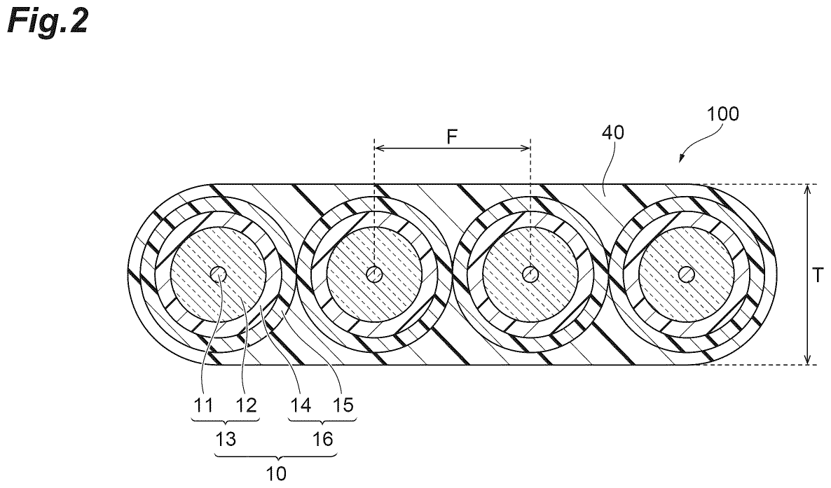

FIG. 2 is a schematic cross-sectional view showing an example of the optical fiber ribbon according to the present embodiment. In FIG. 2, an optical fiber ribbon 100 has a plurality of optical fibers 10 arranged in parallel, and a connecting resin layer 40 in which a plurality of the optical fibers 10 are coated and connected with a resin for the ribbon. In FIG. 2, four optical fibers 10 are shown as an example, though the number thereof is not particularly limited.

The optical fibers 10 in contact with each other in parallel may be integrated, or a part or all of the optical fibers 10 in parallel at regular intervals may be integrated. The distance F between the centers of the adjacent optical fibers 10 may be 220 μm or more and 280 μm or less. In the case where the distance between the centers is controlled to 220 μm or more and 280 μm or less, it is easy to place the optical fibers in existing V-grooves, so that an optical fiber ribbon having excellent batch fusion property can be obtained. The thickness T of the optical fiber ribbon 100 may be 164 μm or more and 285 μm or less, though depending on the outer diameter of the optical fiber 10. The resin for ribbons is not particularly limited, and a connecting resin layer may contain, for example, a urethane (meth)acrylate resin.

### EXAMPLES

The results of evaluation tests in Examples according to the present disclosure and Comparative Examples are shown in the following, and the present disclosure is described in more detail. Note that the present disclosure is not limited to these Examples.

### (First Resin Composition for Primary Resin Layer)

A silicone compound having a vinylsilyl group (divinyl-terminated poly(dimethylsiloxane-diphenylsiloxane), weight average molecular weight: 9500), a silicone compound having a hydrosilyl group (trimethylsilyl-terminated poly(methylhydrosiloxane-dimethylsiloxane), weight average molecular weight: 9000) and a platinum catalyst were mixed to obtain a first resin composition. The platinum catalyst was added such that the amount of platinum contained in the primary resin layer became equal to the amount shown in the following Table 1, and the amounts of the silicone compound having a vinylsilyl group and the silicone compound having a hydrosilyl group added were adjusted such that the molar ratio Si(CH═CH₂)/SiH became equal to 1:1.

### (Second Resin Composition for Secondary Resin Layer)

A second resin composition was obtained by mixing 35 parts by mass of urethane acrylate (Mn: 1300) obtained by reacting polypropylene glycol having a number average molecular weight of 600, 2,4-tolylene diisocyanate and 2-hydroxyethyl acrylate, 30 parts by mass of bisphenol A-based epoxy acrylate, 15 parts by mass of isobornyl acrylate (manufactured by Osaka Organic Chemical Industry Ltd., trade name: IBXA), 18 parts by mass of 2-phenoxyethyl acrylate (manufactured by Kyoeisha Chemical Co., Ltd., trade name: Light Acrylate PO-A), and 1 part by mass of 2,4,6-trimethylbenzoyl diphenylphosphine oxide (TPO).

### (Third Resin Composition for Colored Layer)

A third resin composition was obtained by mixing 75 parts by mass of urethane acrylate obtained by reacting polypropylene glycol having a number average molecular weight of 1000, 2,4-tolylene diisocyanate and 2-hydroxyethyl acrylate, 10 parts by mass of bisphenol A/ethylene oxide-added diol diacrylate, 7 parts by mass of isobornyl acrylate (Osaka Organic Chemical Industry Ltd., trade name: IBXA), 2 parts by mass of 1-hydroxycyclohexane-1-yl phenyl ketone, 3 parts by mass of copper phthalocyanine, and 3 parts by mass of titanium oxide.

### (Resin Composition for Ribbon)

A resin composition for ribbon was obtained by mixing 18 parts by mass of urethane acrylate obtained by reacting 1 mol of bisphenol A/ethylene oxide-addition diol, 2 mol of tolylene diisocyanate and 2 mol of hydroxyethyl acrylate, 10 parts by mass of urethane acrylate obtained by reacting 1 mol of polytetramethylene glycol, 2 mol of tolylene diisocyanate and 2 mol of hydroxyethyl acrylate, 15 parts by mass of tricyclodecane diacrylate obtained by reacting 1 mol of tolylene diisocyanate and 2 mol of hydroxyethyl acrylate, 10 parts by mass of N-vinylpyrrolidone, 10 parts by mass of isobornyl acrylate, 5 parts by mass of bisphenol A/ethylene oxide addition diol diacrylate, 0.7 parts by mass of Irgacure 907, and 1.3 parts by mass of TPO.

### (Optical Fiber)

The first resin composition was applied to the outer circumference of a glass fiber having a diameter of 125 μm composed of a core and a cladding, and passed through a heat curing furnace at a temperature of 200° C. at a line speed of 50 m/min to be cured, so that a primary resin layer having a thickness of 35 μm was formed. Then the second resin composition was applied to the outer circumference of the primary resin layer and cured by irradiation with ultraviolet rays to form a secondary resin layer having a thickness of 25 μm, so that an optical fiber having a diameter of 245 μm was prepared. Subsequently, the optical fiber was wound once, and then drawn out anew with a coloring machine to form a colored layer having a thickness of 5 μm from the third resin composition on the outer circumference of the secondary resin layer, so that an optical fiber having a diameter of 255 μm with the colored layer (hereinafter, referred to as “colored optical fiber”) was prepared.

### (Amount of Platinum Contained in Primary Resin Layer)

A sample was prepared by adding 7 mL of nitric acid and 1 mL of 46 mass % hydrofluoric acid to 0.05 g of the cured product of the first resin composition and heating at 220° C. for 15 minutes in a microwave decomposition apparatus. Subsequently, pure water was added to the sample to adjust the volume to 50 mL, and the content of platinum was measured using a high frequency inductively coupled plasma emission spectrometer (“ICP-MS Agilent 7700x” manufactured by Agilent Technologies).

### (Preparation of Optical Fiber Ribbon and Evaluation of Adhesion)

A connecting resin layer having a thickness of 15 μm was formed around 12 colored optical fibers arranged in parallel from the resin composition for ribbon, so that an optical fiber ribbon was prepared.

The optical fiber ribbon having a length of 1 m was stored in an environment at 85° C. and a humidity of 85% for 30 days. Then, a terminal of the optical fiber ribbon having a length of several centimeters was separated into single fibers including odd-numbered fibers and even-numbered fibers with a toothpick. Subsequently, the toothpick was moved along the longitudinal direction of the optical fiber ribbon to divide the optical fiber ribbon into an odd-fiber side and an even-fiber side. On this occasion, in the evaluation of the adhesion between the primary resin layer and the secondary resin layer, a case without a separation between the primary resin layer and the secondary resin layer of the optical fiber was evaluated as “A”, and a case with a separation between the primary resin layer and the secondary resin layer of the optical fiber was evaluated as “B”.

TABLE 1

| | Experimental | Experimental | Experimental | Experimental | Experimental | Experimental |
|---|---|---|---|---|---|---|
| | Example 1 | Example 2 | Example 3 | Example 4 | Example 5 | Example 6 |
| Content of | 30 | 100 | 150 | 200 | 20 | 300 |
| platinum | | | | | | |
| (ppm) | | | | | | |
| Adhesion | A | A | A | A | B | B |

From the comparison between Experimental Examples 1 to 4 and Experimental Examples 5 and 6, it has been confirmed that with an amount of platinum contained in the primary resin layer of 25 ppm or more and 280 ppm or less, an optical fiber having superior adhesion between the primary resin layer and the secondary resin layer can be obtained.

### REFERENCE SIGNS LIST

10: OPTICAL FIBER
11: CORE
12: CLADDING
13: GLASS FIBER
14: PRIMARY RESIN LAYER
15: SECONDARY RESIN LAYER
16: COATING RESIN LAYER
D1: DIAMETER OF CORE 11
D2: OUTER DIAMETER OF GLASS FIBER 13
40: CONNECTING RESIN LAYER
100: OPTICAL FIBER RIBBON
T: THICKNESS OF OPTICAL FIBER RIBBON 100
F: DISTANCE BETWEEN CENTERS OF OPTICAL FIBERS 10 ADJACENT TO EACH OTHER

1. An optical fiber comprising:
a glass fiber including a core and a cladding; and
a coating resin layer for coating the glass fiber,
wherein the coating resin layer has a primary resin layer in contact with the glass fiber for coating the glass fiber, and a secondary resin layer for coating the primary resin layer;
the primary resin layer contains a silicone resin;
the secondary resin layer contains a urethane (meth)acrylate resin; and
an amount of platinum contained in the primary resin layer is 25 ppm or more and 280 ppm or less in a mass ratio.

2. The optical fiber according to claim 1, wherein the primary resin layer is a cured product of a first resin composition containing a silicone compound having a vinylsilyl group, a silicone compound having a hydrosilyl group, and a platinum catalyst.

3. The optical fiber according to claim 1, wherein the secondary resin layer is a cured product of a second resin composition containing a urethan (meth)acrylate and a photopolymerization initiator.

4. The optical fiber according to claim 3, wherein the second resin composition further contains an epoxy (meth)acrylate having an aromatic ring.

5. An optical fiber ribbon comprising:
a plurality of the optical fibers according to claim 1 arranged in parallel; and
a connecting resin layer for coating and connecting a plurality of the optical fibers.

6. The optical fiber according to claim 2, wherein the secondary resin layer is a cured product of a second resin composition containing a urethan (meth)acrylate and a photopolymerization initiator.

7. The optical fiber according to claim 6, wherein the second resin composition further contains an epoxy (meth)acrylate having an aromatic ring.
